(19) United States
(12) Patent Application Publication
(10) Pub. No.: US 2025/0357770 A1
(43) Pub. Date: Nov. 20, 2025

(54) POWER TOOL INCLUDING DUAL BATTERY PACK SEQUENTIAL DISCHARGE

(71) Applicant: MILWAUKEE ELECTRIC TOOL CORPORATION, Brookfield, WI (US)

(72) Inventors: Joseph W. Miller, Waukesha, WI (US); Evan M. Glanzer, Milwaukee, WI (US); John P. Carroll, Brookfield, WI (US); Kevin Steward, Libertyville, IL (US); Joseph C. Reiter, Milwaukee, WI (US)

(21) Appl. No.: 19/211,914

(22) Filed: May 19, 2025

Related U.S. Application Data
(60) Provisional application No. 63/649,735, filed on May 20, 2024.

(51) Int. Cl. H02J 7/00; B25F 5/02; E04F 21/24

(52) U.S. Cl. CPC H02J 7/0025; B25F 5/02; E04F 21/248; H02J 7/0047; H02J 7/007182

(57) ABSTRACT

A power tool includes a housing, a motor within the housing, a user interface, a first battery pack interface configured to receive a first battery pack, a second battery pack interface configured to receive a second battery pack, and a controller connected to the motor, the user interface, the first battery pack interface, and the second battery pack interface. The controller is configured to detect that the first battery pack is connected to the first battery pack interface, detect that the second battery pack is connected to the second battery pack interface, drive the motor via a discharge of the first battery pack, detect that the first battery pack is depleted, and, in response to detecting that the first battery pack is depleted, drive the motor via a discharge of the second battery pack.

### RELATED APPLICATIONS

This application claims the benefit of U.S. Provisional Patent Application No. 63/649,735, filed May 20, 2024, the entire content of which is hereby incorporated by reference.

### FIELD

Embodiments described herein relate to power tools powered by battery packs.

### SUMMARY

Some power tools, such as power trowels, are used continuously for extended periods of time to perform a particular task. Power trowels are typically used to apply a smooth finish to concrete.

Applying a smooth finish to concrete may be time consuming task when the area to be smoothed is large. During such a task, a battery pack powered power trowel may deplete the battery pack, causing an interruption of work and potentially causing downtime for the work crew while a replacement battery pack is located and charged.

Power tools (e.g., power trowels) described herein include a dual battery pack interface and electronics configured to implement a sequential discharge scheme for discharging multiple connected battery packs one at a time to drive an electric motor of the power tool. When a first of the multiple battery packs has reached an end of discharge condition, a second of the multiple battery packs is switched to discharge so that the second of the multiple battery packs drives the motor.

Power tools described herein include a housing, a motor within the housing, a user interface, a first battery pack interface configured to receive a first battery pack, a second battery pack interface configured to receive a second battery pack, and a controller connected to the motor, the user interface, the first battery pack interface, and the second battery pack interface. The controller is configured to discharge the first battery pack until the first battery pack is depleted, stop the discharge of the first battery pack in response to the first battery pack being depleted, discharge the second battery pack until the second battery pack is depleted, and stop the discharge of the second battery pack in response to the second battery pack being depleted.

In some implementations, a power tool includes a first battery pack interface configured to receive a first battery pack and a second battery pack interface configured to receive a second battery pack. The first battery pack interface and the second battery pack interface are connected in parallel. The first battery pack interface and the second battery pack interface are configured to provide power from the first battery pack and the second battery pack for powering a motor of the power tool. A discharge control circuit connected to the first battery pack interface and the second battery pack interface is configured to select either the first battery pack or the second battery pack for initial discharge, and to discharge the selected battery pack until it is depleted. The discharge control circuit is configured to then select the other battery pack for discharge and discharges the other battery pack to depletion.

In some implementations, a power tool includes a housing, a motor within the housing, a user interface, a first battery pack interface configured to receive a first battery pack, a second battery pack interface configured to receive a second battery pack, and a controller connected to the motor, the user interface, the first battery pack interface, and the second battery pack interface. The controller is configured to detect that the first battery pack is connected to the first battery pack interface, detect that the second battery pack is connected to the second battery pack interface, drive the motor via a discharge of the first battery pack, detect that the first battery pack is depleted, and, in response to detecting that the first battery pack is depleted, drive the motor via a discharge of the second battery pack.

In some implementations, a system includes a motor, a user interface, a first battery pack interface configured to receive a first battery pack, a second battery pack interface configured to receive a second battery pack, and a controller connected to the motor, the user interface, the first battery pack interface, and the second battery pack interface. The controller is configured to detect that the first battery pack is connected to the first battery pack interface, detect that the second battery pack is connected to the second battery pack interface, drive the motor via a discharge of the first battery pack, detect that the first battery pack is depleted, and, in response to detecting that the first battery pack is depleted, drive the motor via a discharge of the second battery pack.

In some implementations, a method for controlling a power tool includes detecting, using a controller, that a first battery pack is connected to a first battery pack interface, detecting, using the controller, that a second battery pack is connected to a second battery pack interface, driving, using the controller, a motor via a discharge of the first battery pack, determining, using the controller, that the first battery pack is depleted, and driving, using the controller and in response to detecting that the first battery pack is depleted, the motor via a discharge of the second battery pack.

Other aspects of the embodiments will become apparent by consideration of the detailed description and accompanying drawings.

### BRIEF DESCRIPTION OF DRAWINGS

FIG. 1A is a perspective view of a power tool according to some implementations of the present disclosure.

FIG. 1B is another perspective view of the power tool of FIG. 1A, according to some implementations of the present disclosure.

FIGS. 1C and 1D show a top view and a front view, respectively, of an example power tool of FIG. 1A including a vertically top-loaded battery pack mounting configuration.

FIGS. 1E and 1F show a top view and front view, respectively, of an example power tool of FIG. 1A, including a vertically top-loaded battery pack mounting configuration.

FIGS. 1G and 1H show a side view and front view, respectively, of the power tool of FIG. 1A, including a horizontally side-loaded battery pack mounting configuration.

FIGS. 1I and 1J show a side view and front view, respectively, of the power tool of FIG. 1A, including a horizontally side-loaded battery pack mounting configuration.

FIGS. 1K and 1L show a top view and a side view, respectively, of the power tool of FIG. 1A, including a horizontally front-loaded battery pack mounting configuration.

FIGS. 1M and 1N show a top view and a side view, respectively, of the power tool of FIG. 1A, including a horizontally back-loaded battery pack mounting configuration.

FIGS. 1O and 1P show a side view and a top view, respectively of the power tool of FIG. 1A, including a horizontally side-loaded battery pack mounting configuration.

FIGS. 1Q and 1R show a side view and a top view, respectively of the power tool of FIG. 1A, including a horizontally side-loaded battery pack mounting configuration.

FIGS. 1S and 1T show a top view and front view, respectively, of the power tool of FIG. 1A, including a horizontally front-loaded battery pack mounting configuration.

FIGS. 1U and 1V show a top view and rear view, respectively, of the power tool of FIG. 1A, including a horizontally back-loaded battery pack mounting configuration.

FIG. 2 is a user interface for the power tool of FIG. 1A, according to some implementations of the present disclosure.

FIG. 3 illustrates a block diagram of a controller for the power tool of FIG. 1A, according to some implementations of the present disclosure.

FIG. 4 is a block diagram of the power tool of FIG. 1A, according to some implementations of the present disclosure.

FIG. 5 is another block diagram of the power tool of FIG. 1A, according to some implementations of the present disclosure.

FIG. 6 is a diagram of a charge pump circuit included in the power tool of FIG. 1A, according to some implementations of the present disclosure.

FIG. 7 is a diagram of a capacitor pre-charge circuit included in the power tool of FIG. 1A, according to some implementations of the present disclosure.

FIG. 8 is a diagram of a direct current (“DC”) link sensor circuit included in the power tool of FIG. 1A, according to some implementations of the present disclosure.

FIG. 9 is a diagram of a solid state device (“SSD”) sensor circuit included in the power tool of FIG. 1A, according to some implementations of the present disclosure.

FIG. 10 is a flow diagram of a method of sequentially discharging battery packs to drive a motor of a power tool, according to some implementations of the present disclosure.

### DETAILED DESCRIPTION

Power tools, such as power trowels, include one or more battery packs configured to drive a motor of the power tool. If the power tool includes more than one battery pack, the battery packs can be discharged sequentially to drive the motor of the power tool. As a result, the amount of time that the power tool can be operated without a wired power connection can be extended.

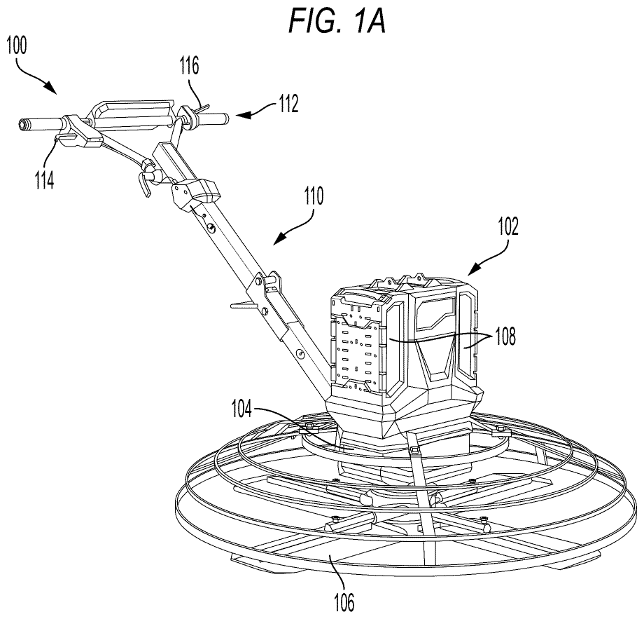

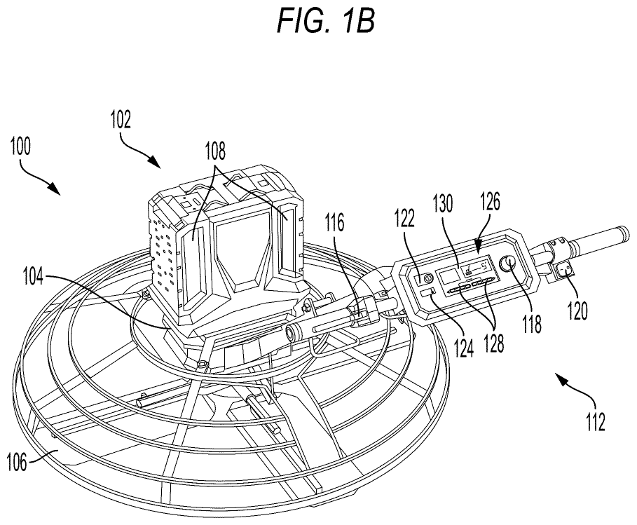

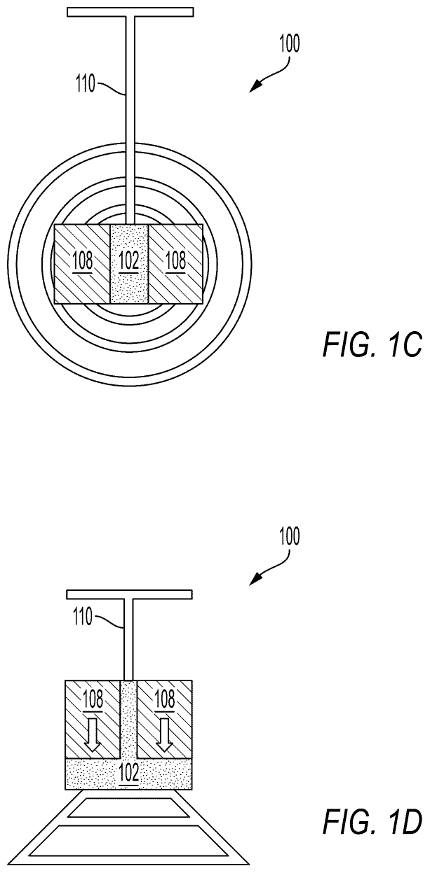

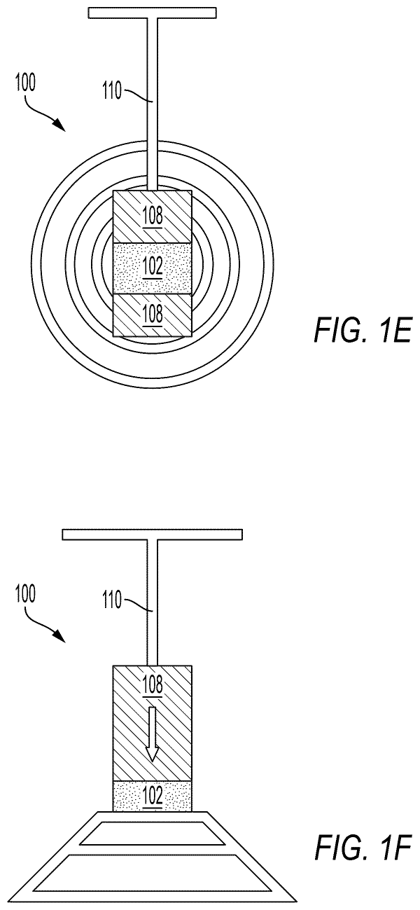

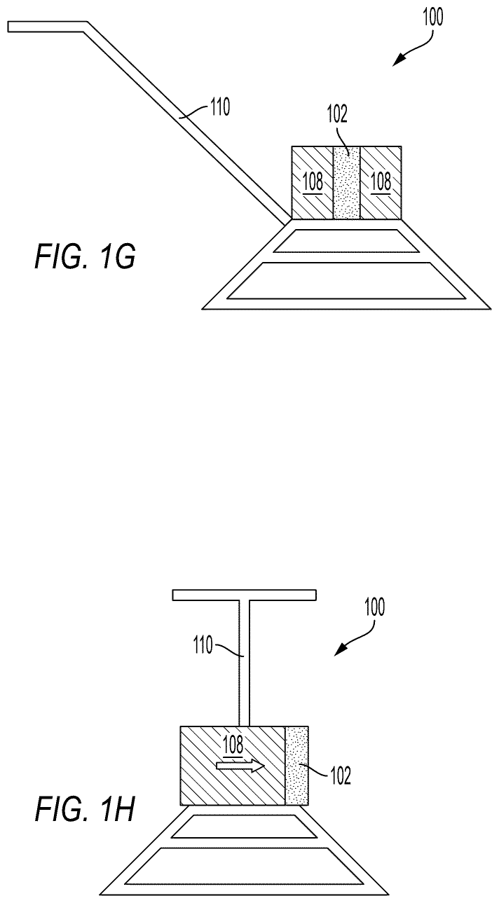

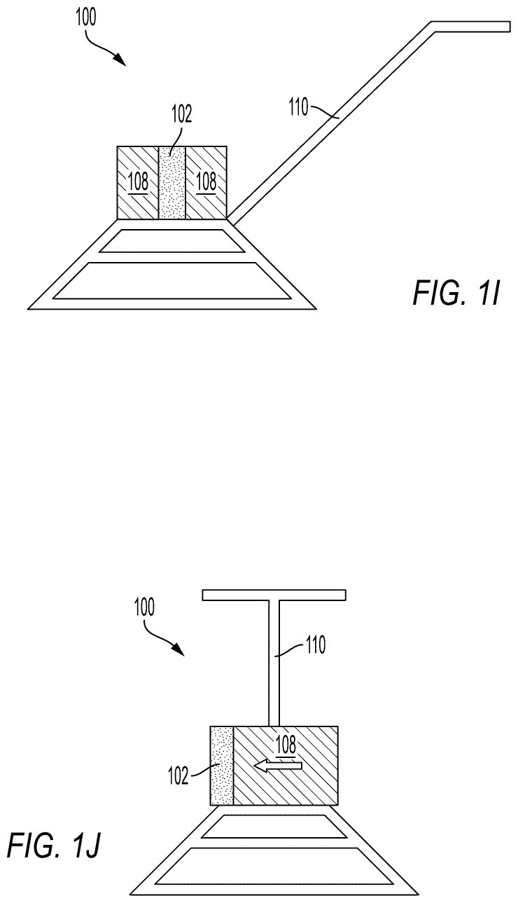

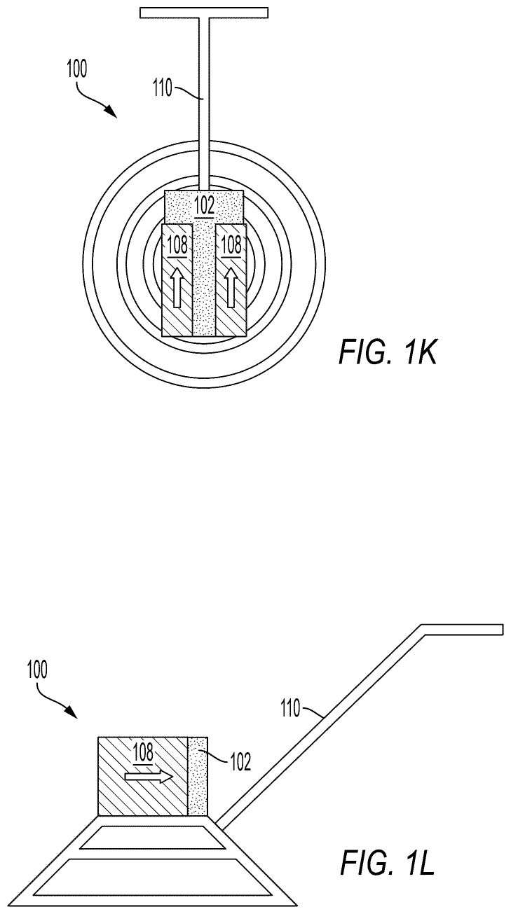

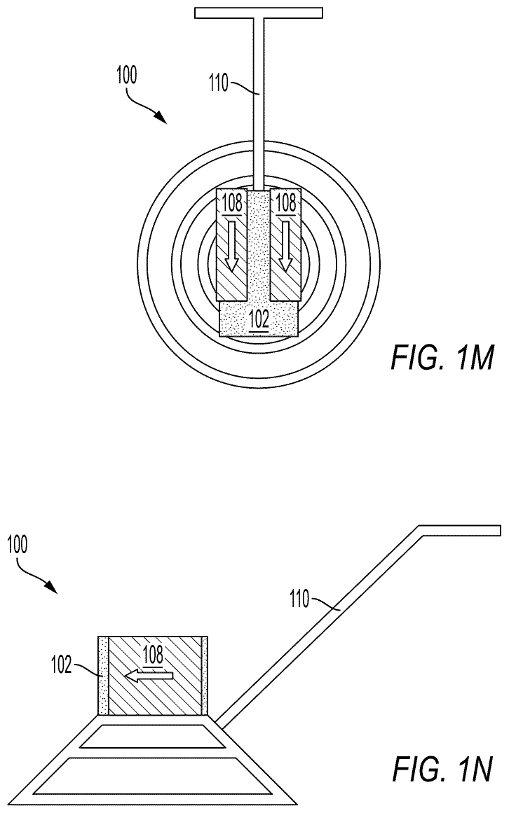

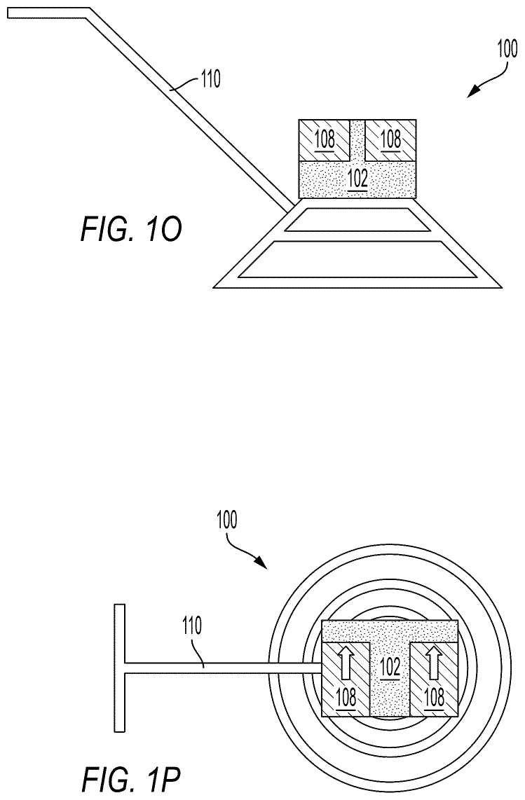

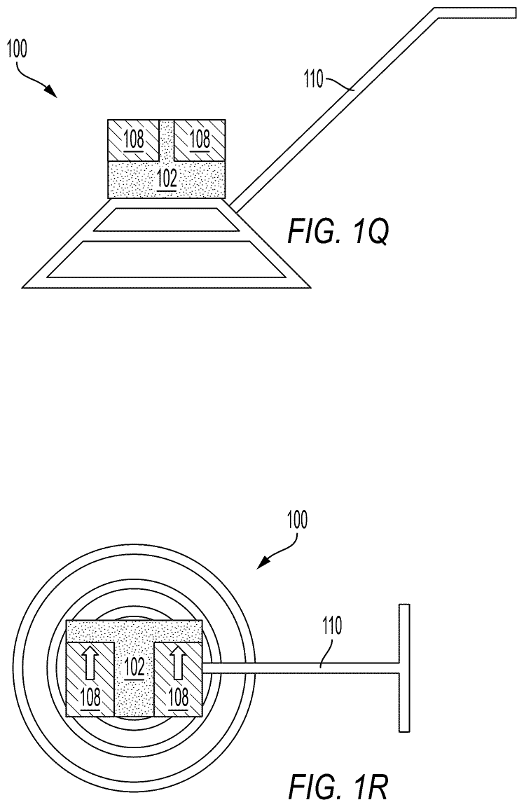

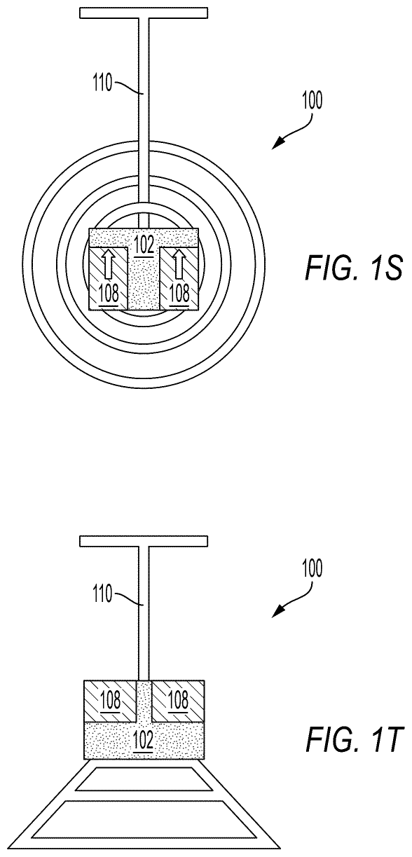

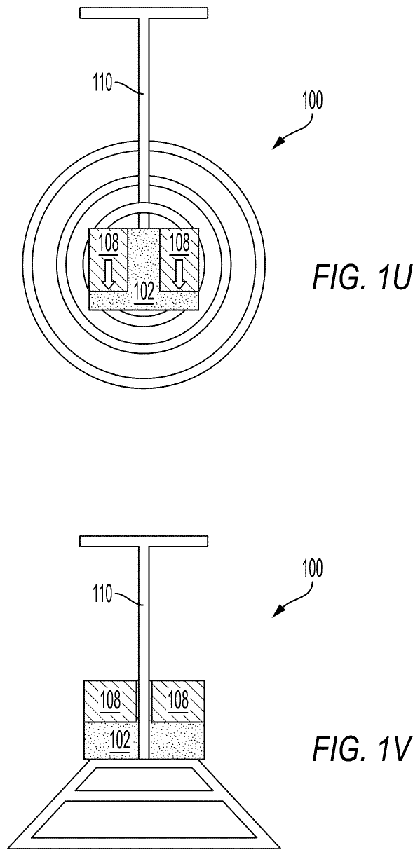

FIGS. 1A and 1B illustrate a perspective view of an example power tool in the form of a power trowel 100. The power trowel 100 includes a motor housing 102, a driveline 104 coupled to the motor housing 102 (e.g., by a plurality of fasteners), and a plurality of trowel blades 106 extending from an output shaft (e.g., a driveshaft) of the driveline 104. Dual battery pack interfaces (e.g., mounting rails and terminals) accommodate battery packs 108 (e.g., rechargeable lithium ion battery packs). A handle portion 110 is mounted to the motor housing 102 or the driveline 104. The handle portion is configured to allow a user to direct the movement of the power trowel 100. A user interface 112 is connected to the handle portion 110 and includes a user input device (e.g., a touchscreen, a trigger, a button, a dial, a toggle, etc.).

An electric motor, supported within the motor housing 102, receives power from the battery packs 108 via the battery pack interfaces when the battery packs 108 are coupled to the battery interfaces. The motor housing 102 may include an airflow system and/or a water drainage system. The airflow system may include an air intake, a dust separating structure, and/or air conduits for cooling of the battery packs 108. The air intake may be located on an exterior surface of the motor housing 102 and be configured to allow outside air to flow into the motor housing 102. The dust separating structure may be positioned downstream from the air intake and configured to extract dust particles from the air that flows into the air intake. The dust separating structure may be a passive dust separating structure (e.g., an inertial dust separating structure) configured to guide the dust particles towards one or more air outlets positioned in the motor housing 102 to expel the dust from the motor housing 102. In some embodiments, the inertial dust separating structure includes a vortex generator assembly, a cyclone, and/or a baffle arrangement arranged in the motor housing 102, between the battery packs 108.

The air conduits may be hollow conduits configured to guide air from a blower (e.g., a blower positioned in the motor housing, between the battery packs 108) toward the battery packs 108. In some embodiments, the blower is a fan. In some embodiments, two air conduits are located in the motor housing 102 (e.g., on opposite sides of the motor housing 102, between the battery packs 108). An end of each air conduit may be located at the output of the blower and configured to direct an airflow produced at an output of the blower to the battery packs 108 to cool them. In some embodiments, the air conduits may be formed of a resilient material and are accordingly less prone to break down over time due to the vibration of the power trowel 100 during operation.

The water drainage system may include a water barrier and a drainage conduit. The water barrier may be configured to divert a flow of water away from the motor and the battery packs 108. The water barrier, which may be a protruding structure on the motor housing 102, may be configured to guide water of an upper side of the motor housing 102 and thereby prevent water from accumulating on the motor housing 102 and leaking into the motor housing 102 or between the motor housing 102 and the battery packs 108. The drainage conduit may be configured to guide a flow of water through a portion of the motor housing 102 from an upper side of the motor housing 102, past the battery compartment, to a drainage opening located below the upper side of the motor housing 102. In some embodiments, the drainage conduit is used in conjunction with the water barrier, the water barrier being positioned such that the water barrier guides water to the drainage conduit for drainage away from the motor housing 102.

In the illustrated embodiment, the motor is a brushless direct current (“BLDC”) motor with a stator and an output shaft or rotor that is rotatable about an axis relative to the stator. In other embodiments, other types of motors may be used. In the embodiment shown, the driveline includes a motor, a clutch, a transmission, a driveshaft, and a gear assembly. The driveline components work together to transfer power from the motor to the trowel blades 106.

In the embodiment shown, the user interface 112 includes a drive trigger 114, a brake lever 116, a trowel blade angle adjustment dial 118, an on/off toggle 120, a tool arming button 122, a connection indicator 124, and an electronic display 126. The electronic display 126 includes state of charge indicators 128 and a trowel blade angle indicator 130. In other embodiments, the user interface 112 may include other indicators such as a motor speed indicator or a level (e.g., showing the angle of the power trowel 100).

The drive trigger 114 is configured to be actuated to drive the motor. In the embodiment shown, actuating the drive trigger 114 causes power to be drawn from the battery packs 108 for driving the motor to continuously operate the gear assembly and the driveline 104. A driveshaft of the driveline 104 operates to rotate the trowel blades 106 when driven by the motor. The brake lever 116 is configured to be depressed to halt or slow the rotation of the trowel blades 106 by braking the driveshaft or motor. An operator may set the angle of the trowel blades 106 using the trowel blade angle adjustment dial 118. In some embodiments, the blade angle adjustment dial 118 is replaced by discrete buttons or a self-centering 3-position rocker switch configured to allow the operator of the power trowel 100 to increase the angle and or decrease the angle of the trowel blades 106. The trowel blade angle indicator 130 is configured to display the current angle of the trowel blades 106. Adjusting the angle of the trowel blades may allow the operator to move more material (e.g., concrete) at a steeper blade angle, and smooth the material at a shallower blade angle. The on/off toggle 120 may be configured to cause the battery pack interfaces to electrically connect the battery packs 108 to electrical components in the motor housing 102. The tool arming button 122 may be configured to enable the drive trigger 114 to be actuated by an operator to cause the motor to draw current from the battery packs 108 and drive the gear assembly of the power trowel 100.

Although the description above in the context of FIGS. 1A and 1B is with reference to the power trowel 100, the battery packs 108, motor housing 102, air flow system, water drainage system, and user interface 112 may be incorporated into other power tools (e.g., a cutoff saw, a plate compactor, a core drill, a jack hammer, a concrete vibrator, a concrete saw, a light, a vibratory screed, etc.). Additionally, as shown in FIGS. 1C-IV, the battery packs 108 may be mounted to the power trowel 100 in various configurations.

FIGS. 1C and 1D show a top view and a front view, respectively, of an example power trowel 100 of FIG. 1A including a vertically top-loaded battery pack mounting configuration. In this configuration, the battery packs 108 are connected to battery terminals of the motor housing 102 by lowering the battery packs 108 vertically from a top of the motor housing 102 toward a bottom of the motor housing 102 until they make contact with terminals disposed on the motor housing 102. When connected to the motor housing 102, the battery packs 108 are oriented orthogonal to the ground (e.g., rails perpendicular to the ground) and are arranged on opposing sides of the handle portion 110.

FIGS. 1E and 1F show a top view and front view, respectively, of an example power trowel 100 of FIG. 1A, including a vertically top-loaded battery pack mounting configuration. In this configuration, the battery packs 108 are connected to battery terminals of the motor housing 102 by lowering the battery packs 108 vertically from a top of the motor housing 102 toward a bottom of the motor housing 102 (e.g., rails perpendicular to the ground) until they make contact with terminals disposed on the motor housing 102. When connected to the motor housing 102, one of the battery packs 108 is arranged on a back of the motor housing 102, near the handle portion 110, while the other battery pack is arranged on a front of the motor housing, away from the handle portion 110.

FIGS. 1G and 1H show a side view and front view, respectively, of the power trowel 100 of FIG. 1A, including a horizontally side-loaded battery pack mounting configuration. In this configuration, the battery packs 108 are connected to battery terminals of the motor housing 102 by sliding the battery packs 108 horizontally from a side of the motor housing 102 toward an opposite side of the motor housing 102 until they make contact with terminals disposed on the motor housing 102. When connected to the motor housing 102, the battery packs 108 are oriented perpendicular to the ground (e.g., rails perpendicular to the ground) and are both arranged on the same side of the handle portion 110.

FIGS. 1I and 1J show a side view and front view, respectively, of the power trowel 100 of FIG. 1A, including a horizontally side-loaded battery pack mounting configuration. In this configuration, the battery packs 108 are connected to battery terminals of the motor housing 102 by sliding the battery packs 108 horizontally from a side of the motor housing 102 toward an opposite side of the motor housing 102 until they make contact with terminals disposed on the motor housing 102. When connected to the motor housing 102, the battery packs 108 are oriented perpendicular to the ground (e.g., rails perpendicular to the ground) and are both arranged on the same side of the handle portion 110.

FIGS. 1K and 1L show a top view and a side view, respectively, of the power trowel 100 of FIG. 1A, including a horizontally front-loaded battery pack mounting configuration. In this configuration, the battery packs 108 are connected to battery terminals of the motor housing 102 by sliding the battery packs 108 horizontally from a front of the motor housing 102 toward a back of the motor housing 102 until they make contact with terminals disposed on the motor housing 102. When connected to the motor housing 102, the battery packs 108 are oriented perpendicular to the ground (e.g., rails perpendicular to the ground) and are arranged on the opposing sides of the handle portion 110.

FIGS. 1M and 1N show a top view and a side view, respectively, of the power trowel 100 of FIG. 1A, including a horizontally back-loaded battery pack mounting configuration. In this configuration, the battery packs 108 are connected to battery terminals of the motor housing 102 by sliding the battery packs 108 horizontally from a back of the motor housing 102 toward a front of the motor housing 102 until they make contact with terminals disposed on the motor housing 102. When connected to the motor housing 102, the battery packs 108 are oriented perpendicular to the ground (e.g., rails perpendicular to the ground) and are arranged on the opposing sides of the handle portion 110.

FIGS. 1O and 1P show a side view and a top view, respectively of the power trowel 100 of FIG. 1A, including a laterally side-loaded battery pack mounting configuration. In this configuration, the battery packs 108 are connected to battery terminals of the motor housing 102 by sliding the battery packs 108 horizontally from a side of the motor housing 102 toward an opposite of the motor housing 102 until they make contact with terminals disposed on the motor housing 102. When connected to the motor housing 102, the battery packs 108 are oriented parallel to the ground (e.g., rails parallel to the ground) and are both arranged on the same side of the handle portion 110.

FIGS. 1Q and 1R show a side view and a top view, respectively of the power trowel 100 of FIG. 1A, including a laterally side-loaded battery pack mounting configuration. In this configuration, the battery packs 108 are connected to battery terminals of the motor housing 102 by sliding the battery packs 108 horizontally from a side of the motor housing 102 toward an opposite of the motor housing 102 until they make contact with terminals disposed on the motor housing 102. When connected to the motor housing 102, the battery packs 108 are oriented parallel to the ground (e.g., rails parallel to the ground) and are both arranged on the same side of the handle portion 110.

FIGS. 1S and 1T show a top view and front view, respectively, of the power trowel 100 of FIG. 1A, including a laterally front-loaded battery pack mounting configuration. In this configuration, the battery packs 108 are connected to battery terminals of the motor housing 102 by sliding the battery packs 108 horizontally from a front of the motor housing 102 toward a back of the motor housing 102 until they make contact with terminals disposed on the motor housing 102. When connected to the motor housing 102, the battery packs 108 are oriented parallel to the ground (e.g., rails parallel to the ground) and are arranged on the opposing sides of the handle portion 110.

FIGS. 1U and 1V show a top view and rear view, respectively, of the power trowel 100 of FIG. 1A, including a laterally back-loaded battery pack mounting configuration. In this configuration, the battery packs 108 are connected to battery terminals of the motor housing 102 by sliding the battery packs 108 horizontally from a back of the motor housing 102 toward a front of the motor housing 102 until they make contact with terminals disposed on the motor housing 102. When connected to the motor housing 102, the battery packs 108 are oriented parallel to the ground (e.g., rails parallel to the ground) and are arranged on the opposing sides of the handle portion 110.

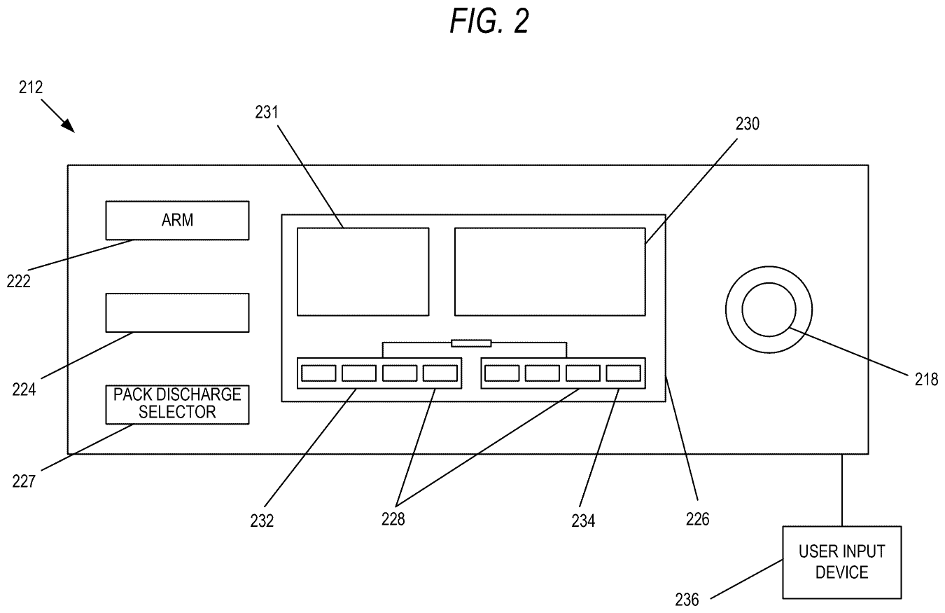

Referring now to FIG. 2, an implementation of a user interface 212 (e.g., user interface 112) for the power trowel 100 is shown. In the embodiment shown, the user interface 212 includes an electronic display 226. The electronic display 226 includes a tool arming button 222, a connection indicator 224, and battery pack discharge selector 227. The electronic display 226 also includes state of charge indicators 228, a trowel blade angle indicator 230, and a display pane 231. The electronic display 226 may be interactive (e.g., a touchscreen display) and allow an operator of the power trowel 100 to manipulate (e.g., select, deselect, drag, slide, etc.) any of the elements shown on the electronic display 226. The state of charge indicators 228 display a state of charge for the first battery pack 108 and a state of charge for the second battery pack 108. In the embodiment shown, the first battery pack state of charge indicator 232 and the second battery pack state of charge indicator 234 are displayed with a plurality of discrete charge indicators (e.g., LEDs) configured to appear or disappear based on the state of charge of the respective battery pack. However, in some embodiments, the state of charge indicators 228 may display a more granular charge indicator such as a percentage indicating a state of charge of the relevant battery pack. In some embodiments, only one state of charge indicator is provided, and the state of charge indicator indicates the state of charge of the lowest state of charge battery pack.

An operator may actuate the battery pack discharge selector 227 to toggle between selecting a first battery pack 108 for discharge and selecting a second battery pack 108 for discharge while operating the power trowel. In such an example, toggling between selecting the first battery pack 108 for discharge and selecting the second battery pack 108 for discharge may include highlighting the battery pack that is selected for discharge on the state of charge indicators 232, 234 (e.g., by illuminating a box around the selected battery pack state of charge indicator). In some embodiments, the battery pack discharge selector 227 is configured to enable a user to change which battery pack is being discharged before the battery pack that is being discharged is depleted.

The user interface 212 includes the trowel blade angle adjustment dial 218 that is configured to be adjusted to set the angle of the trowel blades 106. A trowel blade angle indicator 230 is configured to display the current angle of the trowel blades 106. In the embodiment shown, the user interface 212 includes a connection indicator 224 that is configured to indicate whether a wireless connection (e.g., a Bluetooth connection) has been established between the power trowel 100 and another device (e.g., smart phone). The display pane 231 may be configured to display warnings or alerts to a user, boot screens, or images such as a company logo or a camera feed. The user interface 212 includes a user input device 236. The user input device 236 may include an additional button, toggle, dial, touchscreen, etc., and may control some other aspect of the power trowel 100. For example, user input device 236 may include the drive trigger 114, the brake lever 116, and the on/off toggle 120 of FIG. 1A. Although, in the embodiment shown, some elements of the user interface 212 are depicted as external to the electronic display 226, it is contemplated that greater or fewer of the elements of the user interface 212 could be implemented as manipulatable digital elements on the electronic display 226.

The user interface 212, may also be configured to show an estimate of minutes of runtime remaining based on a total energy of the installed battery packs 108 and/or a power draw rate of the power trowel 100. The power draw rate shown on the user interface 212 may be configured to assist a user of the power trowel 100 in determining how different settings of the power trowel 100 affect the power drawn by a motor of the power trowel 100. For example, the power draw rate shown on the user interface 212 may assist a user in determining that pitching the trowel blades 106 at certain angles (e.g., angles more perpendicular to the ground) causes the motor to draw more power than when the trowel blades 106 are pitched at other angles (e.g., angles parallel to the ground). The user interface 212 may also be configured to indicate (e.g., by blinking the total energy indicator) when a torque or acceleration of the motor of the power trowel 100 begins to fade due to a low state of charge of battery packs 108. Additionally, the total energy indicator (for example, a battery-shaped icon) may be configured to flash an orange or red pattern when the total energy remaining reaches a predetermined level (e.g., 20%). The user interface 212 may also be configured to display a speed of the trowel blades 106 (e.g., in rotations per minute [RPM] or as a relative indicator [1-10]), and a loss of control engagement indicator is configured to indicate when the power trowel 100 is no longer under the operator's control (e.g., when the handle of the handle portion 110 is dropped, or when the power trowel 100 experiences a sudden, unintended movement).

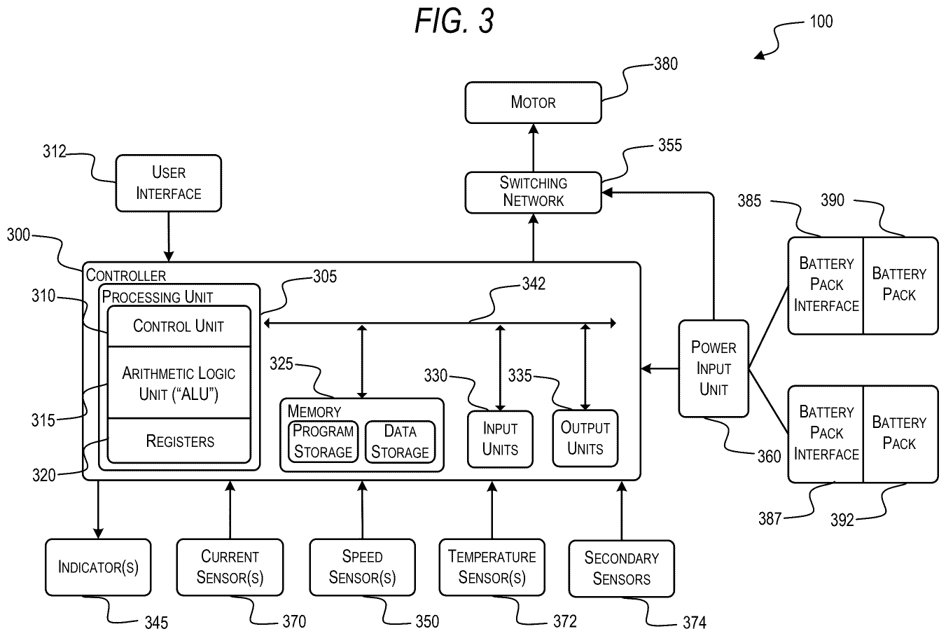

A controller 300 for the power trowel 100 is illustrated in FIG. 3. The controller 300 is electrically and/or communicatively connected to a variety of modules or components of the power trowel 100. For example, the illustrated controller 300 is connected to indicators 345, current sensor(s) 370, speed sensor(s) 350, temperature sensor(s) 372, secondary sensor(s) 374 (e.g., a voltage sensor, an accelerometer, a torque sensor or torque transducer, a gyroscope, an inertial measurement unit [“IMU”], etc.), the user interface 312 (e.g., user interface 112), a power switching network 355, a power input unit 360, and a motor 380.

The controller 300 includes a plurality of electrical and electronic components that provide power, operational control, and protection to the components and modules within the controller 300 and/or power trowel 100. For example, the controller 300 includes, among other things, a processing unit 305 (e.g., a microprocessor, an electronic processor, an electronic controller, a microcontroller, or another suitable programmable device), a memory 325, input units 330, and output units 335. The processing unit 305 includes, among other things, a control unit 310, an arithmetic logic unit (“ALU”) 315, and a plurality of registers 320 and is implemented using a known computer architecture (e.g., a modified Harvard architecture, a von Neumann architecture, etc.). The processing unit 305, the memory 325, the input units 330, and the output units 335, as well as the various modules connected to the controller 300 are connected by one or more control and/or data buses (e.g., common bus 342). The use of one or more control and/or data buses for the interconnection between and communication among the various modules and components would be known to a person skilled in the art in view of the embodiments described herein.

The memory 325 is a non-transitory computer readable medium and includes, for example, a program storage area and a data storage area. The program storage area and the data storage area can include combinations of different types of memory, such as a ROM, a RAM (e.g., DRAM, SDRAM, etc.), EEPROM, flash memory, a hard disk, an SD card, or other suitable magnetic, optical, physical, or electronic memory devices. The processing unit 305 is connected to the memory 325 and executes software instructions that are capable of being stored in a RAM of the memory 325 (e.g., during execution), a ROM of the memory 325 (e.g., on a generally permanent basis), or another non-transitory computer readable medium such as another memory or a disc. Software included in the implementation of the power trowel 100 can be stored in the memory 325 of the controller 300. The software includes, for example, firmware, one or more applications, program data, filters, rules, one or more program modules, and other executable instructions. The controller 300 is configured to retrieve from the memory 325 and execute, among other things, instructions related to the control processes and methods described herein. In other embodiments, the controller 300 includes additional, fewer, or different components.

The controller 300 drives the motor 380 to rotate an output (e.g., a driver) in response to a user's manipulation of the user interface 312 (e.g., depressing drive trigger 114). The output may be coupled to the motor 380 via an output shaft. Manipulation of the user interface 312 may cause power to be drawn from battery packs 390, 392 (e.g., battery packs 108), to drive the motor 380 at a specific speed and in a specific direction. In some embodiments, the controller 300 controls the power switching network 355 (e.g., a FET switching bridge) to drive the motor 380. The power switching network 355 may include, for example, a plurality of high side switching elements (e.g., FETs) and a plurality of low side switching elements (e.g., FETs). The controller 300 may control each switch of the plurality of high side switching elements and the plurality of low side switching elements to drive each phase of the motor 380. For example, the power switching network 355 may be controlled to more quickly deaccelerate the motor 380. In some embodiments, the controller 300 monitors a rotation of the motor 380 (e.g., a rotational rate of the motor 380, a velocity of the motor 380, a position of the motor 380, a rotational direction of the motor 380, and the like) via the speed sensors 350. As described above, the motor 380 may be configured to drive a gearbox (e.g., a mechanism of driveline 104).

The indicators 345 are also connected to the controller 300 and receive control signals from the controller 300 to turn on and off or otherwise convey information based on different states of the power trowel 100. The indicators 345 include, for example, one or more light-emitting diodes (“LEDs”) and/or a display screen (e.g., electronic display 226). The indicators 345 can be configured to display conditions of, or information associated with, the power trowel 100. For example, the indicators 345 can display information relating to an operational state of the power trowel 100, such as a mode or speed setting. The indicators 345 may also display information relating to a fault condition, or other abnormality of the power trowel 100. In addition to or in place of visual indicators, the indicators 345 may also include a speaker or a tactile feedback mechanism to convey information to a user through audible or tactile outputs.

Battery pack interfaces 385, 387 are connected to the controller 300 and configured to couple with battery packs 390, 392, respectively. The battery pack interfaces 385, 387, include a combination of mechanical (e.g., a battery pack receiving portion) and electrical components configured to and operable for interfacing (e.g., mechanically, electrically, and communicatively connecting) the power trowel 100 with the battery packs 390, 392. The battery pack interfaces 385, 387, are coupled to the power input unit 360 and the switching network 355, and transmit the power received from the battery packs 390, 392 to the power input unit 360 and the switching network 355. As will be described in greater detail below, the power input unit 360 may be configured to provide a chargeable power link (e.g., a DC link) for the battery pack interfaces 385, 387, to help avoid an interruption of power supplied to the motor 380 while switching between battery packs 390, 392 during sequential discharge. The power input unit 360 may also include active and/or passive components (e.g., voltage step-down controllers, voltage converters, rectifiers, filters, etc.) to regulate or control the power received through the battery pack interfaces 385, 387, and to the controller 300.

The current sensor(s) 370 sense, for example, a current provided by the battery pack 390, 392, a current associated with the motor 380, or a combination thereof. In some embodiments, the current sensor(s) 370 sense at least one of the phase currents of the motor 380. The current sensor 370 may be, for example, an inline phase current sensor, a pulse-width-modulation-center-sampled inverter bus current sensor, or the like. The speed sensors 350 sense a speed of the motor 380. The speed sensor 350 may include, for example, one or more Hall effect sensors. In some embodiments, the temperature sensor 372 senses a temperature of the switching network 355, the battery pack 390, 392, the motor 380, or a combination thereof.

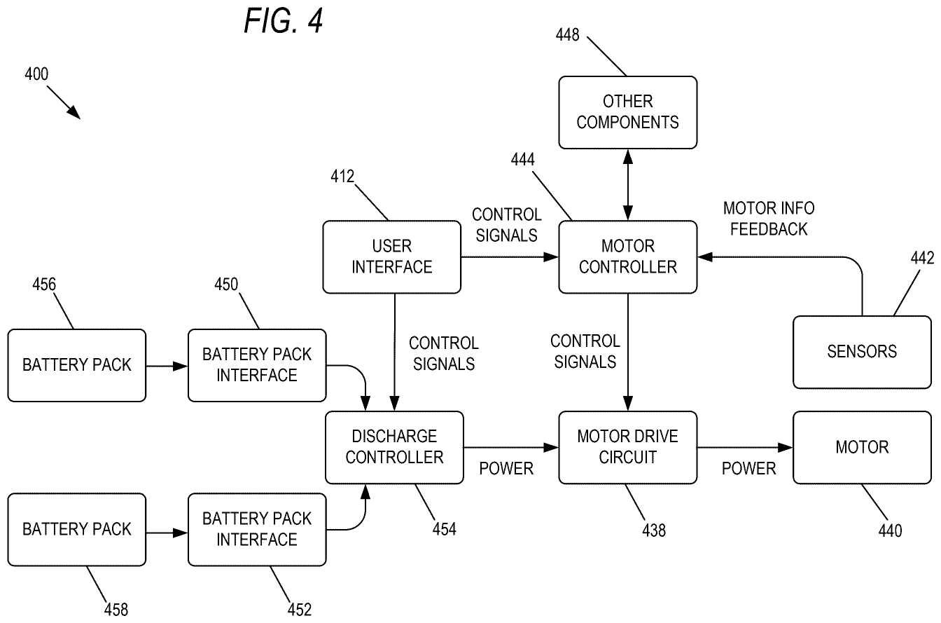

FIG. 4 illustrates a block diagram 400 of the components of the power trowel 100. In the embodiment shown, the power trowel 100 includes a motor drive circuit 438, a motor 440 (e.g., motor 380), sensors 442 (e.g., speed sensors 350), a motor controller 444 (e.g., controller 300), user interface 412 (e.g., user interface 312), and other components 448 (e.g., work lights, indicator lights, etc.). In the embodiment shown, the power trowel 100 includes a first battery pack interface 450, a second battery pack interface 452. The battery pack interfaces 450, 452 may correspond to battery pack interfaces 385, 387. A discharge controller 454 is configured to control the discharge of battery packs 456, 458 (e.g., battery packs 108) connected to the power trowel 100. The discharge controller 454 controls the distribution of DC power to the various components of the power trowel 100 by selecting only one battery pack at a time for discharge.

The motor controller 444 may be implemented using controller 300 and is configured to control the operation of the motor drive circuit 438 (e.g., an inverter bridge circuit such as switching network 355), which drives the motor 440. The sensors 442 may correspond to sensors 370, 350, 372, 374, and may be configured to output signals indicating an operating characteristic of the motor 440. For example, the sensors 442 may be Hall effect sensors configured to output signals including motor feedback information, such as an indication (e.g., a pulse) when a magnet of the rotor rotates across the face of that Hall sensor. Based on the motor feedback information from the sensors 442, the motor controller 444 can determine the position, velocity, and acceleration of the rotor. The sensors 442 can also be configured to sense the operating characteristics of the battery packs 456, 458 (e.g., temperature, state of health, state of charge, voltage, etc.). In some embodiments, the sensors are included in the battery packs 456, 458, or the battery pack interfaces 450, 452. As will be described further below, signals from the sensors 442 may be used by the discharge controller 454 for determining when to switch between battery packs 456, 458 during sequential discharge.

The motor controller 444 and discharge controller 454 may receive a user input from user interface 412, which may correspond to the user interface 112, 312. An operator of the power trowel 100 may provide input to the motor controller 444 by, for example, actuating the drive trigger 114 or the brake lever 116. In response to the motor feedback information and user controls, the motor controller 444 may transmit control signals to the motor drive circuit 438 to drive the motor 440. Although not shown, the motor controller 444 and other components of the power trowel 100 are electrically coupled to the discharge controller 454 such that the discharge controller 454 provides power from the battery packs 456, 458 to the sensors 442, motor controller 444, and the user interface 412. An operator of the power trowel 100 may provide input to the motor drive circuit 438 by, for example, actuating the battery pack discharge selector 227 to manually cause the discharge controller 454 to toggle between providing power to the motor 440 (via the motor drive circuit 438) from either the first battery pack 456 or from the second battery pack 458.

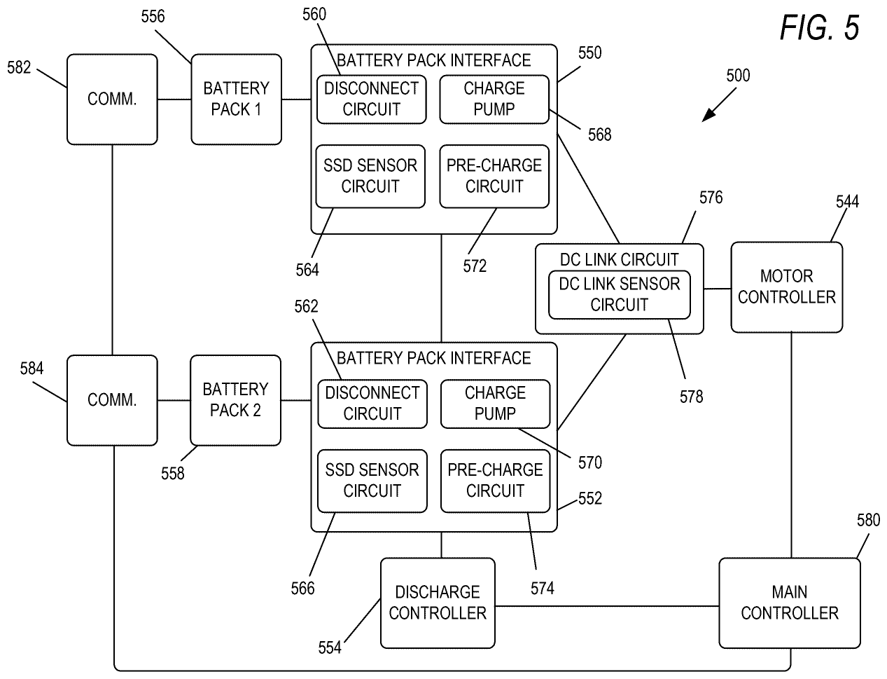

FIG. 5 illustrates a more detailed block diagram 500 of the components of the power trowel 100. The battery pack interfaces 550, 552 (e.g., battery pack interfaces 450, 452) include associated circuits configured to help ensure that the battery packs 556, 558 (e.g., battery packs 456, 458) are each discharged sequentially until depletion or failure (e.g., due to overheating). The battery pack interfaces 550, 552 include, for example, disconnect circuits 560, 562, solid state device (“SSD”) sensor circuits 564, 566, charge pumps 568, 570, and capacitor pre-charge circuits 572, 574. A discharge controller 554 is connected to the battery pack interfaces 550, 552. A DC link circuit 576, which may correspond to power input unit 360, is connected to the battery pack interfaces 550, 552 and includes a DC link sensor circuit 578. The DC link circuit 576 is also connected to the motor controller 544 (e.g., motor controller 444) and is configured to provide current from the battery pack interfaces 550, 552 to the motor controller 544. In the embodiment shown, a main controller 580 (e.g., controller 300) is connected to the discharge controller 554 and the motor controller 544, and is in communication with the battery packs 556, 558 via communication links 582, 584 (e.g., RS485 communication links).

Motor control may be divided between the motor controller 544 and the main controller 580. Accordingly, in some embodiments, the motor controller 544 and the main controller 580 may each be implemented using controller 300. In some embodiments, motor controller 544 is primarily configured to control the operation of the motor 380, while the main controller 580 is configured to primary handle user input. For example, the motor controller 544 may control the operation of motor 380 through the motor drive circuit 438, while the main controller 580 may be communicatively coupled to the drive trigger 114. The drive trigger 114 may be connected to, for example, a potentiometer, a non-contact distance sensor, etc., to determine and provide an indication of a degree (e.g., a distance) to which the drive trigger 114 is actuated to the main controller 580. The main controller 580 may read and processes information from sensors connected to the drive trigger 114 and provide the trigger information to the motor controller 544. In response, the motor controller 544 may perform an open loop or closed loop control of the motor 380 through the motor drive circuit 438 based on the signals received from the main controller 580 (i.e., trigger information).

In the embodiment shown, the battery packs 556, 558 are configured to communicate state of health, state of charge, and operating characteristics of the battery packs 556, 558 to the main controller 580 via the communication links 582, 584. Although the communication links 582, 584 are illustrated as being separate from the battery pack interfaces 550, 552, the communication links 582, 584 can also be included as part of the battery pack interfaces 550, 552. The main controller 580 is configured to communicate with the discharge controller 554 based on the information received from the battery packs. The discharge controller 554 is configured to monitor and control the disconnect circuits 560, 562, the SSD sensor circuits 564, 566, the charge pumps 568, 570, and the capacitor pre-charge circuits 572, 574, based on communications received from the main controller 580. In some embodiments, the discharge controller 454 is configured to switch back and forth between batteries (e.g., by controlling the disconnect circuits 560, 562) to maintain a substantially constant, equal drain rate between the battery packs 556, 558. In some embodiments, the main controller 580 drives the motor 380 according to a closed-loop speed-controlled control scheme (e.g., based on the selection of a specific speed of operation via the user interface 412). In such embodiments, the main controller 580 may be configured to monitor the speed of the motor 380 and to cause the motor controller 544 to regulate the voltage drawn from the battery packs 556, 558 to control the speed of operation of the power trowel 100 (e.g., to maintain a constant speed of the motor 440). If the voltage of one of the battery packs 556, 558 supplying a power to the motor 380 reaches a low-voltage cutoff threshold, the discharge controller 454 may switch from discharging the low voltage battery pack to discharging the a higher voltage battery pack, based on the closed-loop speed-controlled control scheme.

Although the motor controller 444, the main controller 580, and the discharge controller 454 are shown as separate controllers, it is contemplated that, in some implementations, these components could be combined into a single component or controller (e.g., controller 300) and still perform the functions described herein.

The DC link circuit 576 is configured to provide energy for a short period to the motor controller 544 in case of a power interruption (e.g., when switching between discharging the first battery pack 556 and discharging the second battery pack 558). A capacitor of the DC link circuit 576 may act like a short-term backup power source, providing energy to the load until the main power source is restored. The DC link circuit 576 may also include filtering components and protective components configured to support a stable, regulated DC voltage and protecting the load from power spikes or surges.

The disconnect circuit is configured to electrically disconnect the battery packs 556, 558 from the battery pack interfaces 550, 552 in response to a command from the discharge controller. The charge pumps 568, 570, the SSD sensor circuits 564, 566, the capacitor pre-charge circuits 572, 574, and the DC link sensor circuit 578 are described in greater detail below. Although the charge pumps 568, 570 and the capacitor pre-charge circuits 572, 574 are shown as included in the battery pack interfaces 550, 552, it is contemplated that the charge pumps 568, 570 and the capacitor pre-charge circuits 572, 574 could alternatively be included in the power trowel 100 separate from the battery pack interfaces 550, 552.

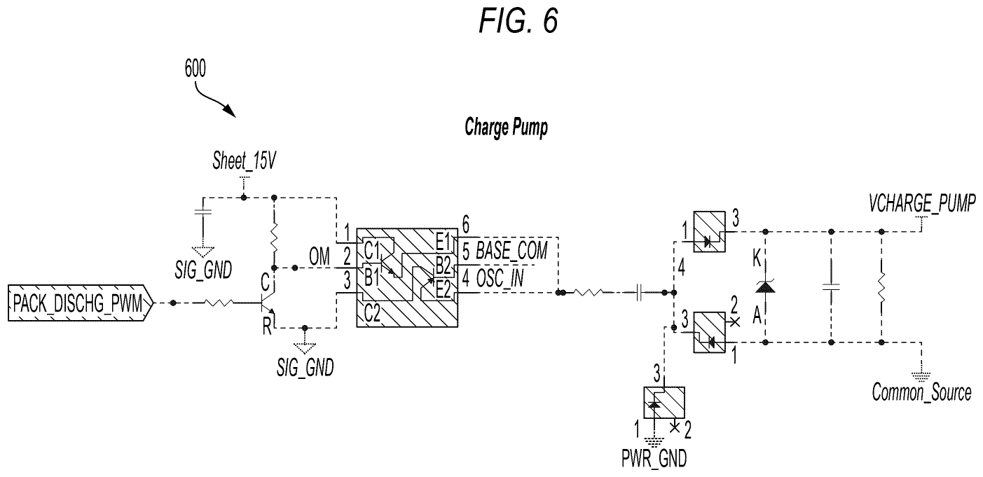

FIG. 6 is a diagram of a charge pump circuit 600 (e.g., charge pump 568, 570) that can be included in the power trowel 100. The charge pump circuit 600 is configured to generate a higher DC voltage output from a lower DC voltage input. The charge pump circuit 600 includes a series of capacitors, diodes, and switches arranged in a configuration configured to boost an input voltage by pumping charge from one end of the circuit to the other. For example, the input voltage signal may be switched on and off, causing energy to be stored and released from a capacitor to raise the output voltage. The capacitor is charged when the input voltage is high and discharged when the input voltage is low. The charge pump circuit 600 may therefore be used to support fault sensing systems in the power tool 100 even if power supplied to those systems drops off while switching between battery packs 556, 558. In the embodiment shown, the charge pump circuit 600 is a discrete charge pump circuit.

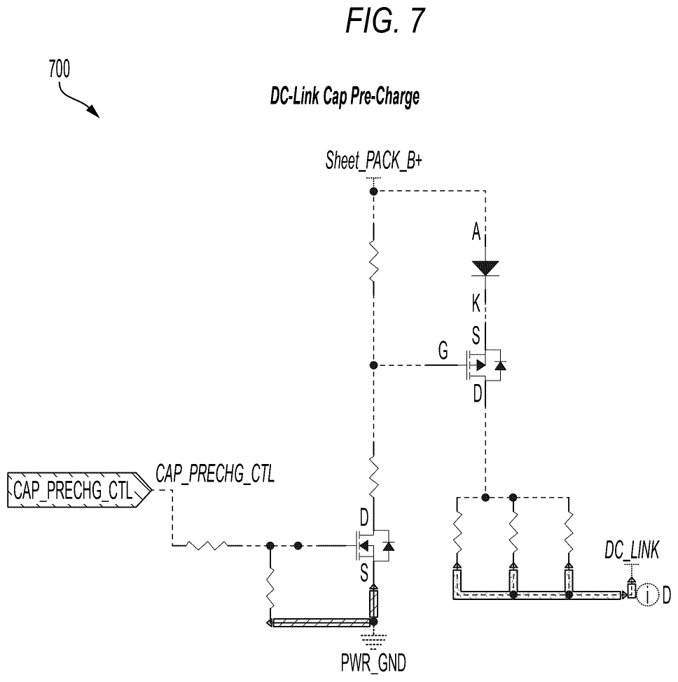

FIG. 7 is a diagram of a capacitor pre-charge circuit 700 included in the power trowel 100. The capacitor pre-charge circuit 700 is configured to charge a capacitor of the DC link circuit 576 from either of the battery packs 556, 558 prior to energizing the motor 440. The pre-charge circuit 700 may help ensure that the DC link circuit 576, described above, is fully functional during the operation of the motor controller 544, the motor drive circuit 438, and/or the motor 440. In the embodiment shown, the capacitor pre-charge circuit 700 is a high-side capacitor pre-charge circuit including high-voltage capacitors and is located on a high-voltage side of the electrical system of the power tool 100. However, it is contemplated that the capacitor pre-charge circuit 700 may also be a low-side capacitor pre-charge circuit including low-voltage capacitors, located on a low-voltage side of the electrical system of the power tool 100.

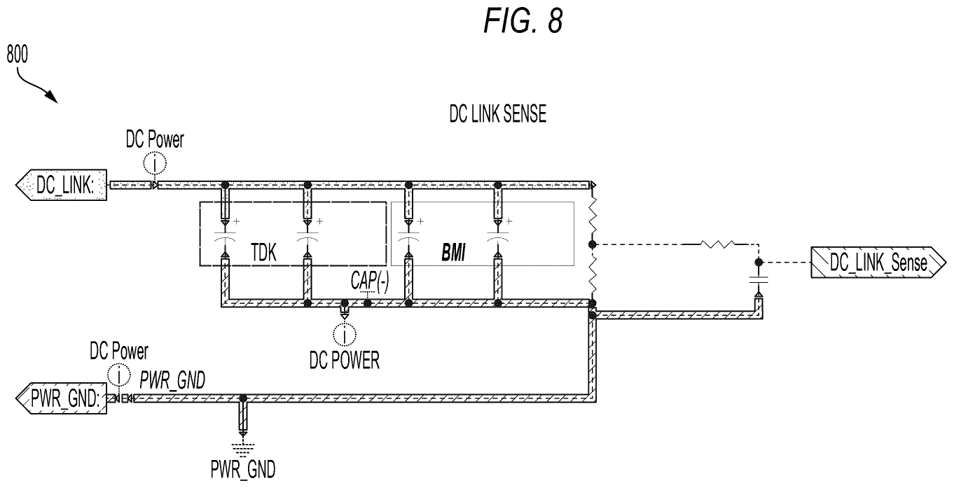

FIG. 8 is a diagram of a DC link sensor circuit 800 included in the power trowel 100. The DC link sensor circuit 800 includes components configured to generate a signal indicating a charge state of one or more capacitors in the DC link circuit 576. For example, the DC link sensor circuit 800 is configured to sense a charge state of the capacitors in order to determine whether the capacitor(s) of the DC link circuit 576 are pre-charged. The DC link sensor circuit 800 may be configured to monitor a voltage of the DC link circuit 576 (e.g., a voltage of the one or more capacitors). In some circumstances, if the voltage of the DC link circuit 576 falls below a threshold (e.g., during a fault), the battery packs 556, 558 may be automatically disconnected to prevent a an outrush of current from the battery cells into the DC link capacitor. Such an outrush could result in violation of the safe operating area for one of the MOSFETs, leading to permanent damage to the power trowel 100.

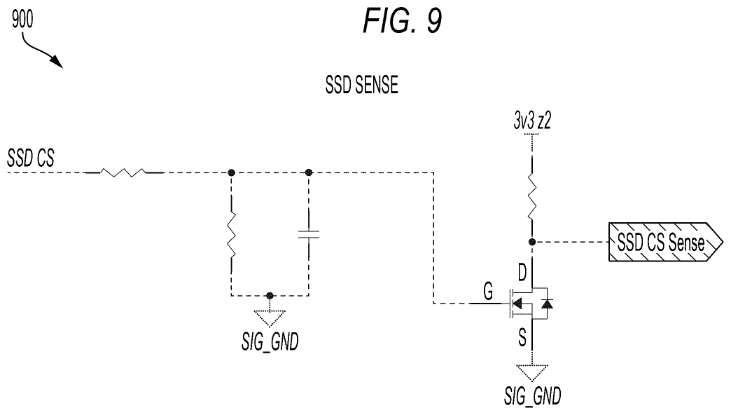

FIG. 9 is a diagram of an SSD sensor circuit 900 included in the power trowel 100. The SSD sensor circuit 900 includes components configured to generate a signal indicating whether a solid state device (e.g., a transistor) of one of the battery pack interfaces 550, 552 is open or closed to disconnect a respective battery pack (e.g., battery pack 556 or battery pack 558) connected to one of the battery pack interfaces 550, 552. In some embodiments, the SSD sensor circuit 900 is also configured to sense a fault condition in a solid state device (e.g., a short). For example, the SSD sensor circuit 900 may be configured to disconnect one of the battery packs 556, 558 when it senses that a solid state device of the SSD in electrical communication with the battery pack 556, 558 is faulted. Disconnecting the battery pack 556, 558 under such circumstances may prevent pack-to-pack charging that could harm the battery pack 556, 558.

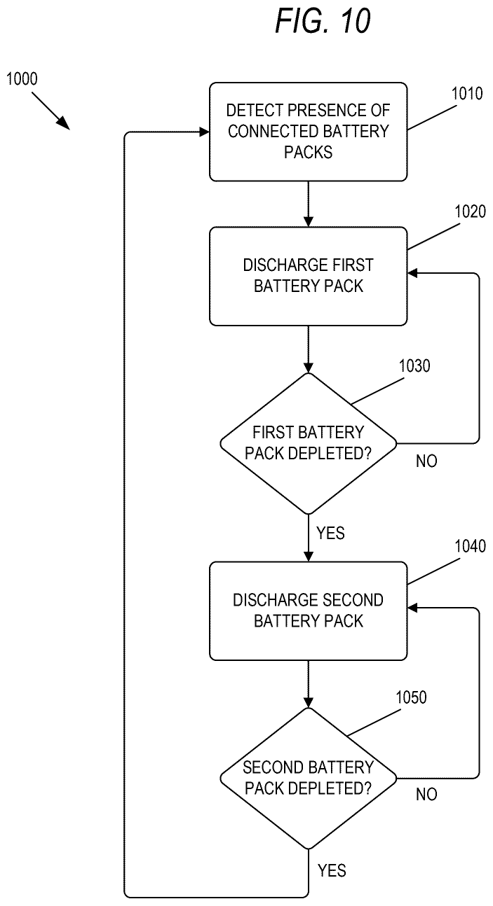

FIG. 10 is a flow diagram of a process 1000 of sequentially discharging battery packs to drive the motor 380 of the power trowel 100. At block 1010, the main controller 580 (or controller 300) detects that battery packs 556, 558, are connected to the battery pack interfaces 550, 552. Connecting the battery packs 556, 558 to the battery pack interfaces 550, 552 establishes, for example, a communicative connection between the battery packs 556, 558 and the main controller 580 via the communication links 582, 584. In some embodiments, determining that any one of the battery packs 556, 558 is connected to any one of the battery pack interfaces 550, 552 includes determining that the connected battery pack is in a suitable state for discharge. Determining whether the connected battery pack is in a suitable state for discharge may include the main controller 580 processing signals indicative of the state of the connected battery pack (e.g., state of charge, temperature, etc.) from sensors in the battery pack interfaces 550, 552, or signals received from the battery packs themselves 556, 558 via the battery pack interfaces 550, 552. In some embodiments, the user interface 412 allows an operator of the trowel to input a state of charge threshold for the battery packs 556, 558, indicating a state of charge (e.g., 10%) at which the discharge controller 554 will take action (e.g., via the disconnect circuits 560, 562) to switch which of the battery packs 556, 558 is discharging. In some embodiments, the user interface 412 allows an operator of the trowel to input a temperature threshold (e.g., 140° F.) for the battery packs 556, 558 at which the discharge controller 554 will take action to switch which one of the battery packs 556, 558 is discharging. By switching which one of the battery packs 556, 558 is discharging, the battery pack having the high temperature is allowed to cool while the other battery pack discharges. In some embodiments the main controller 580 is configured to predict a rate at which the discharging battery pack will increase in temperature. The main controller 580 may also be configured to monitor the temperature of the discharging battery pack and predict an amount of time remaining until the operating temperature of the active battery reaches a predetermined temperature threshold. The user interface 412 may also be configured to display the estimated amount of time remaining to the operator of the power trowel 100.

In some embodiments, the power trowel 100 does not include sensors configured to sense a temperature of the battery packs 556, 558 and the controller 300 does not set temperature thresholds for the battery packs 556, 558. Instead, the battery packs themselves are configured to monitor their own temperature and to disconnect from the power trowel 100 upon overheating (e.g., reaching a predetermined temperature threshold, overheating to the point of battery failure, etc.). Additionally, in some embodiments, the discharge controller 554 is configured to switch between battery packs based on a detected battery pack malfunction (e.g., a sudden drop in voltage, a detection of a high internal impedance, etc.).

At block 1020, the discharge controller 554 initiates discharge of the first battery pack 556. The first battery pack 556 may be chosen for discharge initially according to a default setting of the discharge controller 554, as described in greater detail below. In some embodiments, the main controller 580 initiates discharge of the first battery pack 556 via the discharge controller 554 by issuing the discharge controller 554 a command indicating the first battery pack 556 should be discharged (for example, in response to a user actuating the discharge selector 227). In some embodiments, the first battery pack to be discharged corresponds to the connected battery pack having the highest state of charge. In some embodiments, the first battery pack to be discharged corresponds to the connected battery pack having the lowest state of charge (e.g., that can still be discharged). In some embodiments, the first battery pack to be discharged corresponds to the connected battery pack having the lowest temperature. In some embodiments, the first battery pack to be discharged corresponds to the first battery pack that was connected to the power trowel 100 or the battery pack that has been connected to the power trowel 100 for the longest period of time.

At block 1030, the discharge controller 554 detects that the first battery pack 556 is depleted (e.g., has reached a low-voltage cutoff threshold). The discharge controller may detect that the first battery pack 556 is depleted via sensors associated with the battery pack interface 550, or via a signal from the main controller 580 indicating that the battery pack is depleted or has failed/malfunctioned. For example, the first battery pack 556 may indicate to the main controller 580, via the communication link 582, that the first battery pack 556 is overheated or has reached the low-voltage cutoff threshold.

At block 1040 the discharge controller 554 initiates discharge of the second battery pack 558. In some embodiments, the main controller 580 initiates discharge of the second battery pack 558 via the discharge controller 554 by sending a command to the discharge controller 554 indicating the second battery pack 558 should be discharged. Switching from the first battery pack 556 to the second battery pack 558 based on battery voltage, rather than state of charge, helps to retain a consistent/constant speed of the power trowel, and may prevent the power trowel 100 from experiencing a jerk due to a sudden change in speed when switching from a lower voltage battery pack (providing a lower operation speed) to a higher voltage battery pack (providing a high operation speed).

At block 1050, the discharge controller 554 detects that the second battery pack 558 is depleted. The discharge controller may detect that the second battery pack 558 is depleted via sensors associated with the battery pack interface 552, or via a signal from the main controller 580 indicating that the battery is depleted or has failed/malfunctioned. For example, the second battery pack 558 may indicate to the main controller 580, via the communication link 584, that the second battery pack 558 is overheated or has reached the low-voltage cutoff threshold. The process 1000 then returns back to block 1010 to determine whether the first battery pack 556 is connected and is suitable for discharge.

In some embodiments, the discharge controller 554 is configured to always default to discharging from only one of the battery pack interfaces 550, 552 initially, when both battery packs 556, 558 are connected to the battery pack interfaces 550, 552. For example, the discharge controller 554 may be configured to always begin discharging the first battery pack 556 connected to the first battery pack interface 550 when both battery packs 556, 558 are connected to the battery pack interfaces 550, 552. In some embodiments, the discharge selector 227 can be used to select the default settings for discharge (e.g., to select the rules for which battery pack discharges first when multiple battery packs are connected). If only one of the battery packs 556, 558 is connected, the discharge controller 554 may initiate discharge of that battery pack, regardless of any default settings of the discharge controller 554 or the main controller 580 set for when both of the battery packs 556, 558 are connected.

Although this description generally focuses embodiments including only two battery packs and two battery pack interfaces, it is contemplated that the principles disclosed herein could be extrapolated for use in systems with three or more battery packs and battery pack interfaces.

Although the invention has been described in detail with reference to certain preferred embodiments, variations and modifications exist within the scope and spirit of one or more independent aspects of the invention as described. Various features and advantages are set forth in the following claims.

What is claimed is:

1. A power tool comprising:
a housing;
a motor within the housing;
a user interface;
a first battery pack interface configured to receive a first battery pack;
a second battery pack interface configured to receive a second battery pack; and
a controller connected to the motor, the user interface, the first battery pack interface, and the second battery pack interface, the controller configured to:
detect that the first battery pack is connected to the first battery pack interface,
detect that the second battery pack is connected to the second battery pack interface,
drive the motor via a discharge of the first battery pack,
detect that the first battery pack is depleted, and
drive, in response to detecting that the first battery pack is depleted, the motor via a discharge of the second battery pack.

2. The power tool of claim 1, further comprising:
a direct current (DC) link configured to provide energy for a short period to the controller when switching between discharging the first battery pack and discharging the second battery pack.

3. The power tool of claim 1, wherein, to detect that the first battery pack is depleted, the controller is configured to determine that a voltage of the first battery pack has reached a low-voltage cutoff threshold.

4. The power tool of claim 1, wherein the controller is configured to drive the motor, via the discharge of the first battery pack, at a speed selected via the user interface.

5. The power tool of claim 4, wherein the controller is configured to monitor the speed of the motor and to regulate a voltage drawn from the first battery pack and the second battery pack to control the speed of operation of the motor.

6. The power tool of claim 1, wherein the controller is further configured to:
control an angle of a trowel blade based on a user input received via the user interface.

7. The power tool of claim 1, wherein the user interface includes a battery pack discharge selector configured to select which of the first battery pack and the second battery pack is to be discharged.

8. The power tool of claim 7, wherein the battery pack discharge selector is configured to enable a user to change which battery pack is being discharged before the battery pack being discharged is depleted.

9. The power tool of claim 7, wherein the user interface further includes state of charge indicators configured to display a first state of charge of the first battery pack and a second state of charge of the second battery pack.

10. A system comprising:
a motor;
a user interface;
a first battery pack interface configured to receive a first battery pack;
a second battery pack interface configured to receive a second battery pack; and
a controller connected to the motor, the user interface, the first battery pack interface, and the second battery pack interface, the controller configured to:
detect that the first battery pack is connected to the first battery pack interface,
detect that the second battery pack is connected to the second battery pack interface,
drive the motor via a discharge of the first battery pack,
detect that the first battery pack is depleted, and
drive, in response to detecting that the first battery pack is depleted, the motor via a discharge of the second battery pack.

11. The system of claim 10, further comprising:
a direct current (DC) link configured to provide energy for a short period to the controller when switching between discharging the first battery pack and discharging the second battery pack.

12. The system of claim 10, wherein, to detect that the first battery pack is depleted, the controller is configured to determine that a voltage of the first battery pack has reached a low-voltage cutoff threshold.

13. The system of claim 10, wherein the controller is configured to drive the motor, via the discharge of the first battery pack, at a speed selected via the user interface.

14. The system of claim 13, wherein the controller is configured to monitor the speed of the motor and to regulate a voltage drawn from the first battery pack and the second battery pack to control the speed of operation of the motor.

15. The system of claim 10, wherein the controller is further configured to:
control an angle of a trowel blade based on a user input received via the user interface.

16. The system of claim 10, wherein the user interface includes a battery pack discharge selector for selecting which of the first battery pack and the second battery pack is to be discharged.

17. The system of claim 16, wherein the battery pack discharge selector is configured to enable a user to change which battery pack is being discharged before the battery pack being discharged is depleted.

18. The system of claim 16, wherein the user interface further includes state of charge indicators configured to display a first state of charge of the first battery pack and a second state of charge of the second battery pack.

19. A method for controlling a power tool, the method comprising:
detecting, using a controller, that a first battery pack is connected to a first battery pack interface;
detecting, using the controller, that a second battery pack is connected to a second battery pack interface;
driving, using the controller, a motor via a discharge of the first battery pack;
determining, using the controller, that the first battery pack is depleted; and
driving, using the controller and in response to detecting that the first battery pack is depleted, the motor via a discharge of the second battery pack.

20. The method of claim 19, further comprising:
selecting, using a battery pack discharge selector, which of the first battery pack and the second battery pack is to be discharged.
